(19) United States
(12) Patent Application Publication
(10) Pub. No.: US 2013/0080326 A1
(43) Pub. Date: Mar. 28, 2013

(54) HOUSEHOLD PAYMENT MANAGEMENT AND TRACKING SYSTEM

(71) Applicant: Jeremy Joseph Jacola, Seattle, WA (US)

(72) Inventor: Jeremy Joseph Jacola, Seattle, WA (US)

(21) Appl. No.: 13/433,040

(22) Filed: Mar. 28, 2012

Related U.S. Application Data
(60) Provisional application No. 61/468,116, filed on Mar. 28, 2011.

(51) Int. Cl. G06Q 20/40

(52) U.S. Cl. CPC G06Q 20/40
USPC 705/44

(57) ABSTRACT

An efficient digital tracking and payment system for members of a household, such as minors and guardians. The system allows for minors and guardians to enter into agreements for services (e.g., chores) and rewards through a single portal digital application that tracks services and notify parties of completion thereof. The system also provides a mechanism for funding of payment from one party to the other on mobile devices and computers over the internet. The system also allows guardians so predetermine the allocation of payments to multiple accounts for a minor. A marketplace is also provided which allows minors to purchase goods or services with funds earned by completing services.

### CROSS REFERENCE TO RELATED APPLICATIONS

This application claims priority to U.S. Provisional Application No. 61/468,116 filed Mar. 28, 2011, entitled “An Application to Track and Facilitate Payment of Chores/Services Performed by a Minor by Adult,” which is hereby incorporated by reference in its entirety.

### FIELD OF THE INVENTION

The present invention relates generally services and payment systems, and more particularly, to systems and methods for managing, tracking and facilitating payments between members of a household.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

Guardians (e.g., parents) have in the past made written or oral agreements with minors (e.g., their children) to be rewarded for chores, grades, or accomplishments. By doing so, minors are able learn about financial issues, including saving and spending. Rewarding minors for completing chores or other actions may also give them a sense of responsibility and control in their lives.

### BRIEF DESCRIPTION OF THE DRAWINGS

Exemplary embodiments are illustrated in the referenced figures. It is intended that the embodiments and figures disclosed herein are to be considered illustrative rather than restrictive.

FIG. 1 illustrates a block diagram of a household payment management and tracking system according to an embodiment of the present invention.

FIG. 2 illustrates a process for implementing the household payment management and tracking system of FIG. 1.

FIG. 3 illustrates a graphical display for a parent configuration module for a web application of the household payment management and tracking system.

FIG. 4 illustrates a graphical display for a child configuration module for the web application.

FIG. 5 illustrates a graphical display for a chore management module for the web application.

FIG. 6 illustrates a graphical display for a chore assignment module for the web application.

FIG. 7 illustrates a graphical display for a parent dashboard module for the web application.

FIG. 8 illustrates a graphical display for a child dashboard module for the web application.

FIG. 9 illustrates a graphical display for a child bank management module for the web application.

FIG. 10 illustrates a graphical display for a marketplace module for the web application.

FIG. 11 is a block diagram of an exemplary computer hardware and operating environment in which the systems described herein may be implemented.

### DESCRIPTION OF THE INVENTION

One skilled in the art will recognize many methods, systems, and materials similar or equivalent to those described herein, which could be used in the practice of the present invention. Indeed, the present invention is in no way limited to the methods, systems, and materials described.

Embodiments of the present invention are directed to providing efficient digital tracking and payment systems and methods for agreements between guardians and minors, such as parents and their children. The system allows for minors and guardians to enter into agreements for services (e.g., chores) or other actions in exchange for rewards through a single portal digital application that tracks the services assigned to minors and notifies parties of completion thereof. The system provides a mechanism for funding of payment from one party to another using mobile devices (e.g., smart phones) and computers over the internet. The financial transactions may include transfers from accounts of a parent (“parent accounts”) at one or more financial institutions to accounts of a child (“child accounts”) at one or more financial institutions. The system may also provide internal system monetary accounts for users.

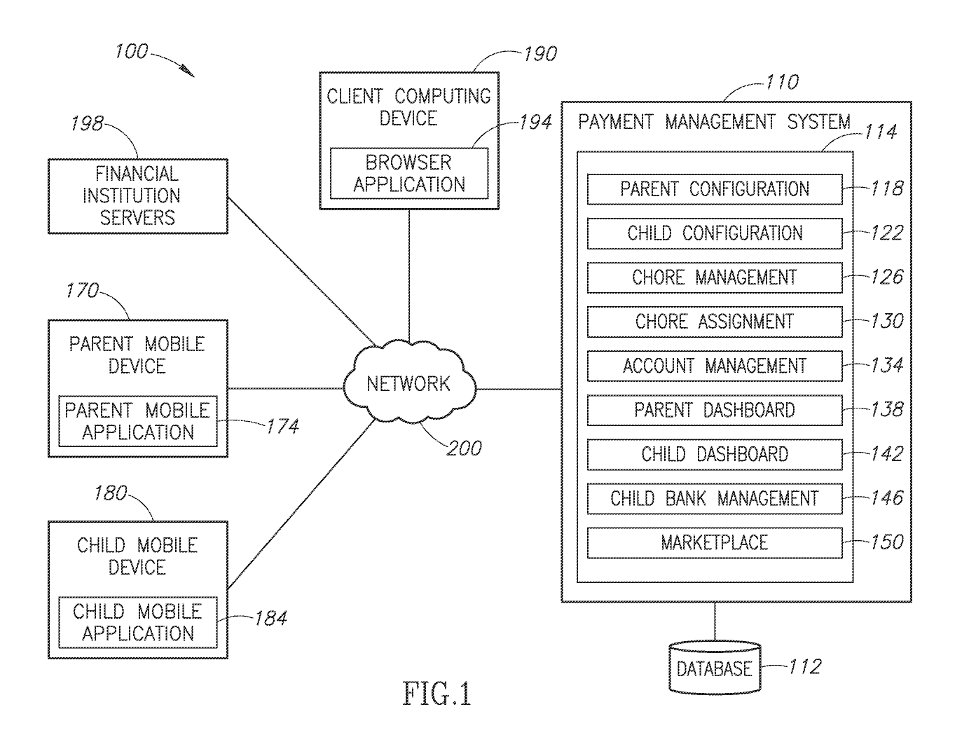

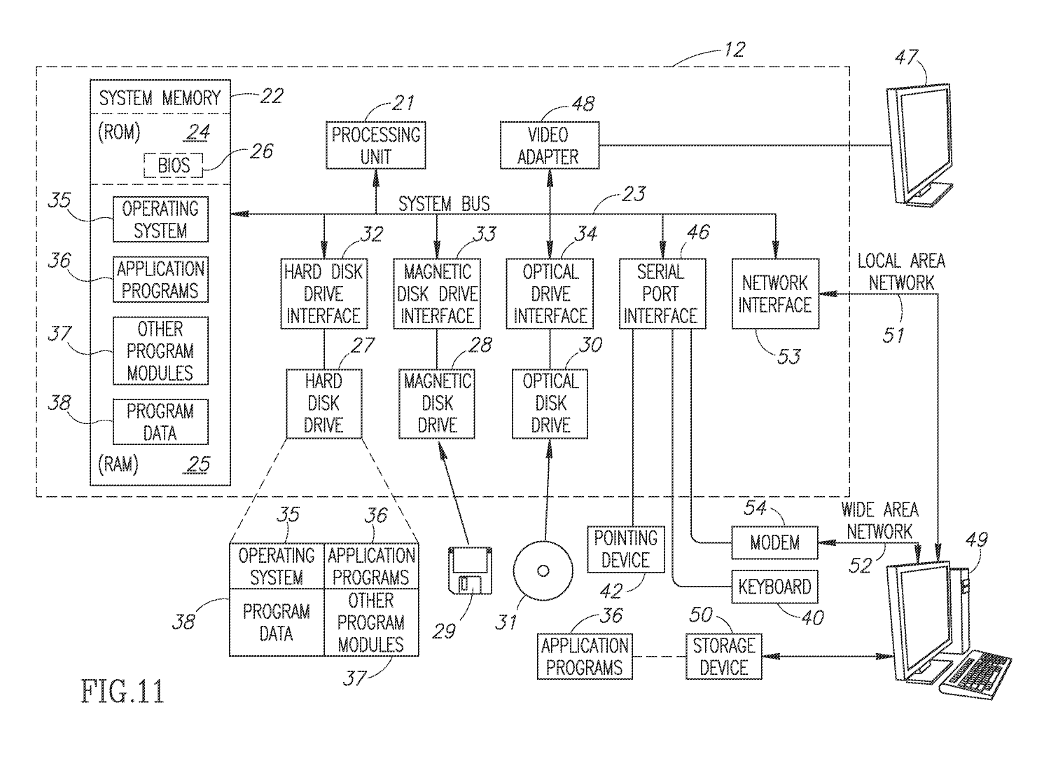

FIG. 1 is a block diagram of a household payment management and tracking system (or “system”) 100 according to an embodiment of the present invention. The system 100 includes at least one payment management system server computing device 110 (e.g., a web server) operative to communicate with a plurality of user or client computing devices (e.g., client computing devices 170, 180, and 190). The server computing device 110 is connected to the client computing devices 170, 180, and 190 by a network 200 (e.g., the Internet), which may be wired, wireless, or any combination thereof. The client computing devices 170, 180, and 190 are each operated by a user, such as a parent and/or a child. By way of non-limiting examples, in FIG. 1, the client computing device 190 may be a personal computer (e.g., a laptop, tablet personal computer, etc.), and the client computing devices 170 and 180 may be mobile devices belonging to a parent and child, respectively. The client computing devices 170, 180, and 190 may be located remotely from the server computing device 110. A block diagram of an exemplary computer hardware and operating environment in which any of the various computing devices described herein may be implemented is shown in FIG. 11, which is described in detail below.

The server computing device 110 is configured with a web application 114 operative to provide a website to the client computing devices 170, 180, and 190. The server computing device 110 is also operative to provide a downloadable parent mobile application 174 for execution on the parent mobile device 170, and a child mobile application 184 for execution on the child mobile device 180. The web application 114 and mobile applications 174 and 184 may provide similar functionality. As can be appreciated, the server computing device 110 may include conventional components and related files operable to display the website on the client computing devices 170, 180, and 190. For example, the server computing device 110 may be operative to cause a web page to be displayed on a display of the client computing devices 170, 180, and 190 when one of the computing devices requests a uniform resource locator (URL) using a web browser application (e.g., a web browser application 194 of the client computing device 190).

The server computing device 110 is also coupled to a database storage 112 operative to store information such as user account/profile information, chores, payments, financial account access authorization information, and the like. The server computing device 110 is also coupled to one or more financial institution servers 198, which allows the system 100 to transfer funds between internal system accounts as well as external accounts held at one or more external financial institutions, such as banks, brokerages, etc.

While the system 100 is illustrated as including the single server computing device 110, those of ordinary skill in the art will appreciate that the system 100 may include any number of server computer devices that each perform the functions of the server computing device 110 or cooperate with one another to perform those functions. Further, while the server computing device 110 is illustrated as being connected to the three client computing devices 170, 180, and 190, those of ordinary skill in the art will appreciate that the server computing device may be connected to any number of client computing devices and the server computing device is not limited to use with any particular number of client computing devices.

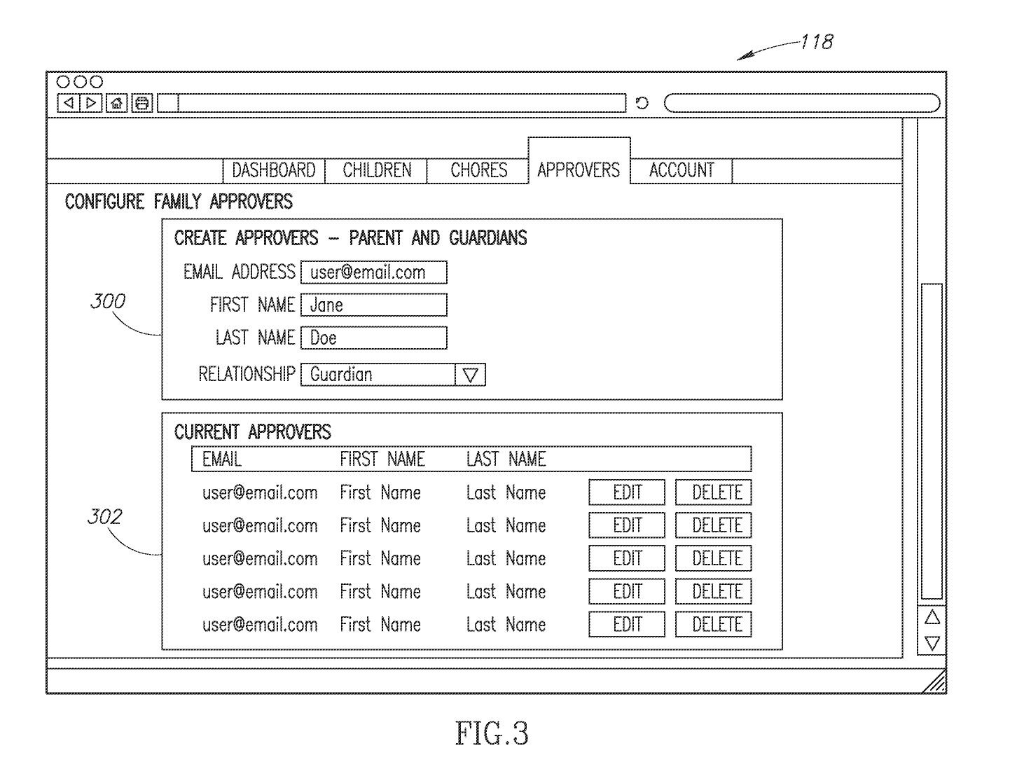

The web application 114 comprises a plurality of functional modules configured to implement the features of the system. Specifically, the web application 114 comprises a parent configuration module 118, a child configuration module 122, a chore management module 126, a chore assignment module 130, an account management module 134, a parent dashboard module 138, a child dashboard module 142, a child bank management module 146, and a marketplace module 150. Some or all of these modules may also be provided on the mobile device applications 174 and 184 that are executable on the parent mobile device 170 and child mobile device 180, respectively. Several of these functional modules are described in further detail below with reference to FIGS. 3-10.

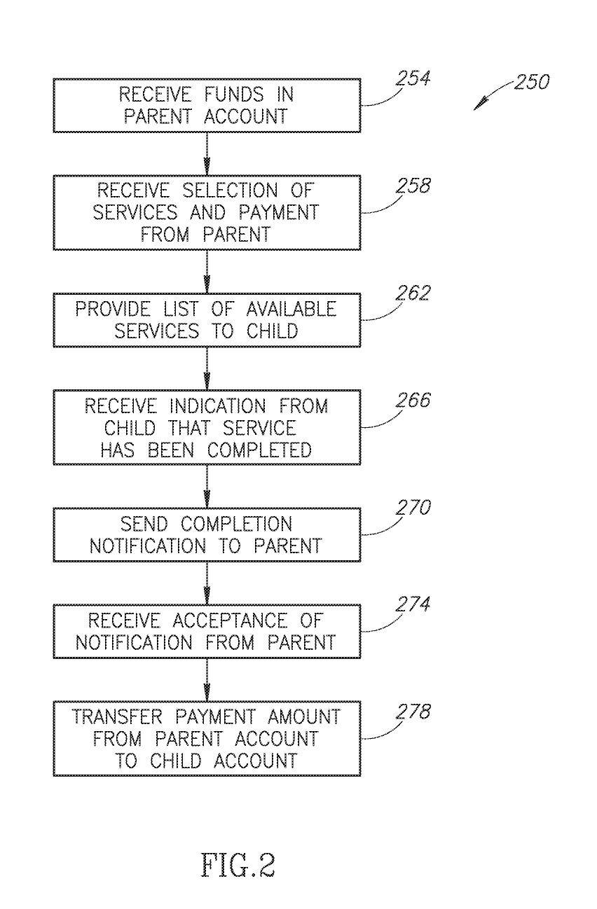

FIG. 2 illustrates a flowchart of a process 250 for implementing the system 100 of FIG. 1. Initially, a parent may sign up for a user account by accessing the web application 114 or by downloading the parent mobile application 174 to his or her mobile computing device 170. The parent may then provide auto-payment/funding information to the system 100 via the account management module 134 for one or more financial institutions at which the parent has an account. The parent's account information is used to transfer funds to a child that has completed a chore. The system 100 includes application programming interfaces (APIs) that allow it to access a plurality of financial institutions, such as banks, credit issuers, e-commerce providers, brokerages, etc. Once the parent has configured one or more external accounts for access, the system 100 may receive funds into the parent's account, step 254. Additionally or alternatively, access to the parent's funds may be established without actually funding a parent's account until payment to a child is needed.

Next, in step 258, the parent may create and assign chores to one or more children in the family and optionally associate a cash value for each of the chores. As an example, the parent may indicate that taking out the garbage is valued at $X dollars and receiving an “A” on a report card is valued at $Y dollars. As discussed below, the parent may also establish an allocation of payments made to a plurality of accounts for a child, such as spending accounts, educational savings accounts, charity accounts, etc. For example, the parent may establish that all payments made to a particular child are to be divided into three accounts, A% for spending money, B% for educational savings, and C% for charity.

In some embodiment, other rewards in addition to or instead of monetary payments may be provided. For example, in some embodiments, the child may earn “stars” for completion of chores. The number of stars associated with a particular chore may be assigned by the parent and/or by the system 100. In some embodiments, the other types of rewards may be redeemable for goods or services.

Once the parent has selected chores and associated payments, a list of chores may be provided to a child, step 262. The child may access the list of chores by executing the child mobile application 184 on his or her mobile device 180 and/or by accessing the web application 114 using the browser application 194 of the client computing device 190. The child is able to view the one or more chores that have been assigned, time periods for completion of each chore, and payments available for completing each of the chores. Once the child has completed a chore, he or she may notify the system 100 by, for example, clicking on a “completed” button for a particular chore, step 266.

The system 100 may then send a notification to the parent or other “approvers” that a child has completed an assigned chore, step 270. The notification may be in any suitable form, including email, text message, voice message, “push” notification, etc. The parent is then provided with an opportunity to approve the completion of the chore, step 274. For example, the parent may wish to first inspect the work before providing an approval. In the case when the child's performance of the chore is unsatisfactory, the parent also has the opportunity “reject” the completion notification and provide feedback to the child via message (e.g., email, text message, application notification, etc.). As an example, for the chore of mowing a lawn, a parent may respond to the child's completion notification with the message “you forgot to mow a portion of the side yard.” The child may then be given another opportunity to complete the chore in a satisfactory manner. This process may be repeated until the parent is satisfied with the child's performance of the chore.

Once the parent has accepted or approved completion of the chore, funds corresponding to the value of the completed chore may be transferred from one of the parent's accounts to the child's account, step 278. The accounts may be internal accounts of the system 100 and/or may be external accounts held at one or more financial institutions. As discussed above, the funds may be allocated to one or more categories as configured by the parent. Further, the parent may determine to which accounts the child has access. For example, a parent may wish to provide access to a spending account but not to a college savings account.

FIGS. 3-10 illustrate various graphical displays for the functional modules of the web application 114. Similar displays may be provided on the parent mobile application 174 and the child mobile application 184 that provide comparable functionality.

FIG. 3 illustrates a graphical display for the parent configuration module 118 of the household payment management and tracking system 100. The module 118 includes a create approvers section 300 that allows parents to add “approvers” to their account. Approvers are people such as parents and guardians that are authorized to approve the completion of chores and initiate payment for completion of chores. In the create approvers section 300, the parent may enter the first and last name of the new approver, his or her email address, and his or her relationship (e.g., parent, guardian, older sibling, etc.) to the child. The system 100 may then use the approver's contact information (e.g., email address) to send them requests for approval of chores completed by a child.

The parent configuration module 118 also includes a current approvers section 302 that provides a list of the names and email addresses of all parents/guardians that have been designated as approvers. Using the current approvers section 302, a parent may edit the profile information for a current approver or delete an approver from the list of current approvers.

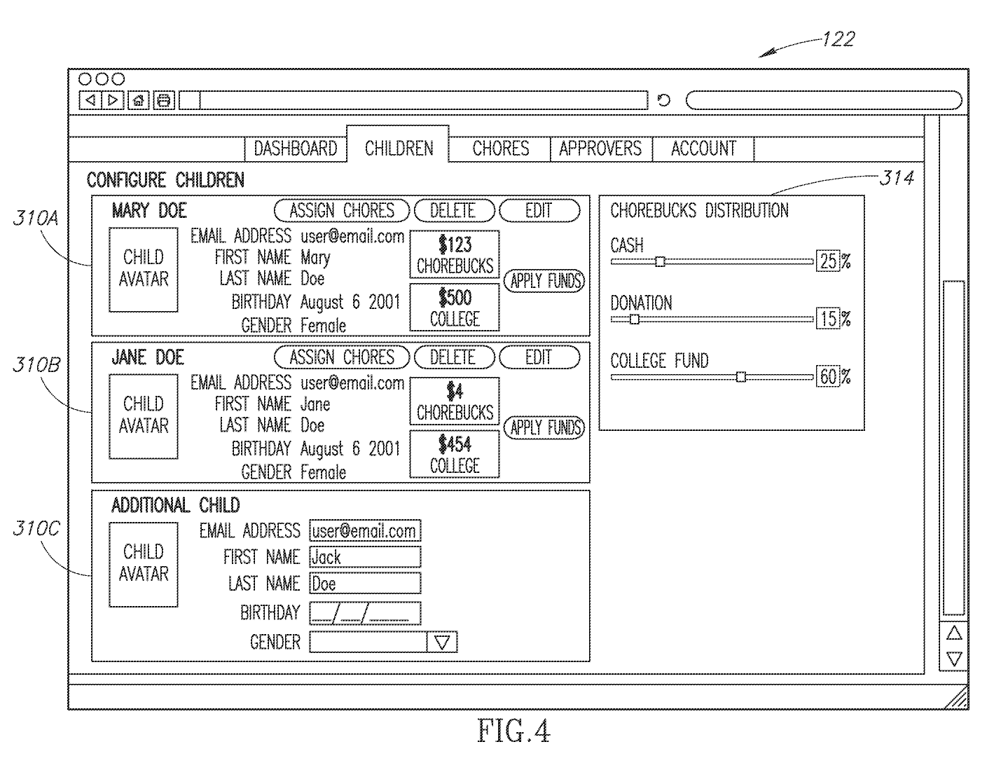

FIG. 4 illustrates a graphical display for the child configuration module 122 of the system 100. The child configuration module 122 includes child information sections 310A and 310B that each includes profile information for a child and permits user actions with respect to a child. As shown, the child information sections 310A and 310B include profile information for each child, including name, email address, birthday, and gender. The sections 310A and 310B also include buttons that allow the parent to edit a child's profile information or delete a child from the system 100. The sections 310A and 310B also show the parent the present value of the child's accounts (e.g., a cash or “chorebucks” account has a value of $123 dollars, and a college savings account has a value of $500 dollars). By selecting an “apply funds” button, the parent can add funds to any of the child's accounts by transferring funds from an account internal to the system 100 or an external account. The sections 310A and 310B also include an “assign chores” button that permits the parent to assign one or more chores to a particular child using the chore assignment module 130, discussed below.

The child configuration module 122 further includes an additional child section 310C which allows parents to add additional children to the system 100 by inputting a child's information including email address, name, birthday, and gender. Once an additional child has been added in the section 310C, a new section similar to sections 310A and 3108 will be created for the newly added child.

The child configuration module 122 also includes a payment distribution or allocation section 314 that allows parents to specify the allocation of payments made to a child. In the example shown in FIG. 4, the parent has allocated 25% of the funds for cash, 15% of the funds for donation purposes, and 60% of the funds for college savings. The allocation may be varied for each child, and may be spread over any number or types of accounts.

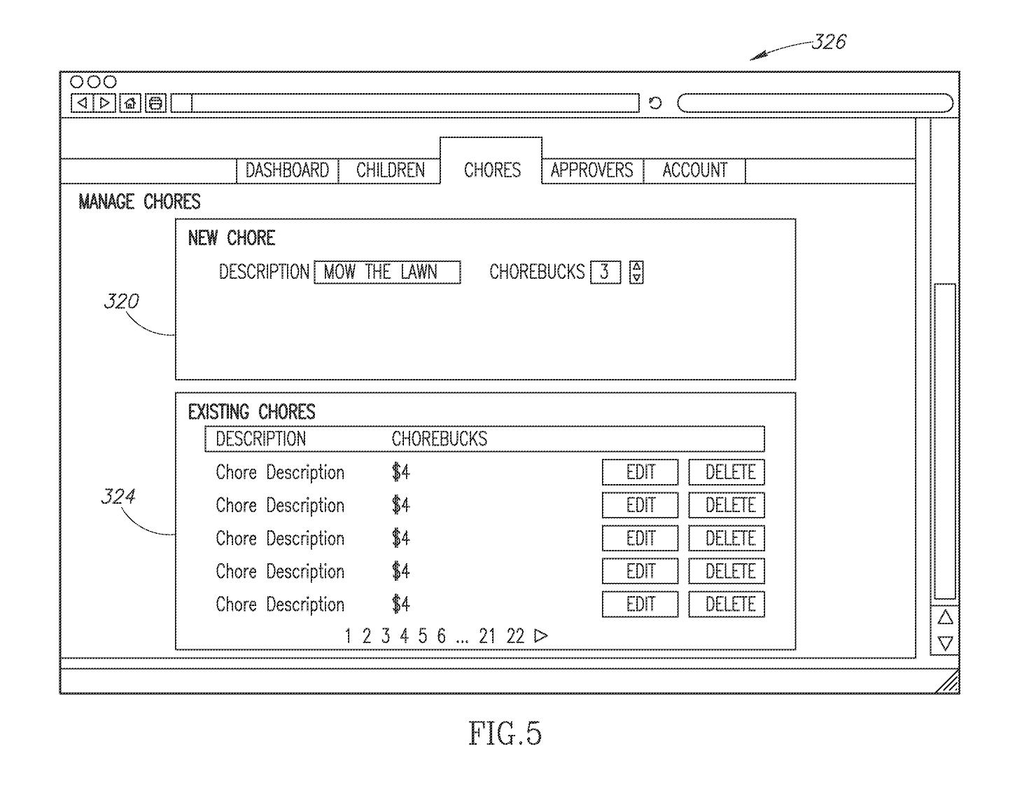

FIG. 5 illustrates a graphical display for the chore management module 126 of the system 100. The chore management module 126 includes a new chore section 320 that allows parents to create a new chore and assign a value (“chorebucks”) to the chore. The new chore section 320 may allow parents to select from a list of pre-defined chores provided by the system 100 and also allows parents to enter a description for a new chore not pre-defined in the system. The chore management module 126 also includes an existing chores section 324 that displays a list of chores previously created and their associated values. The section 324 also provides buttons that allow parents to edit the description and/or value for an existing chore, and to delete an existing chore from the system 100.

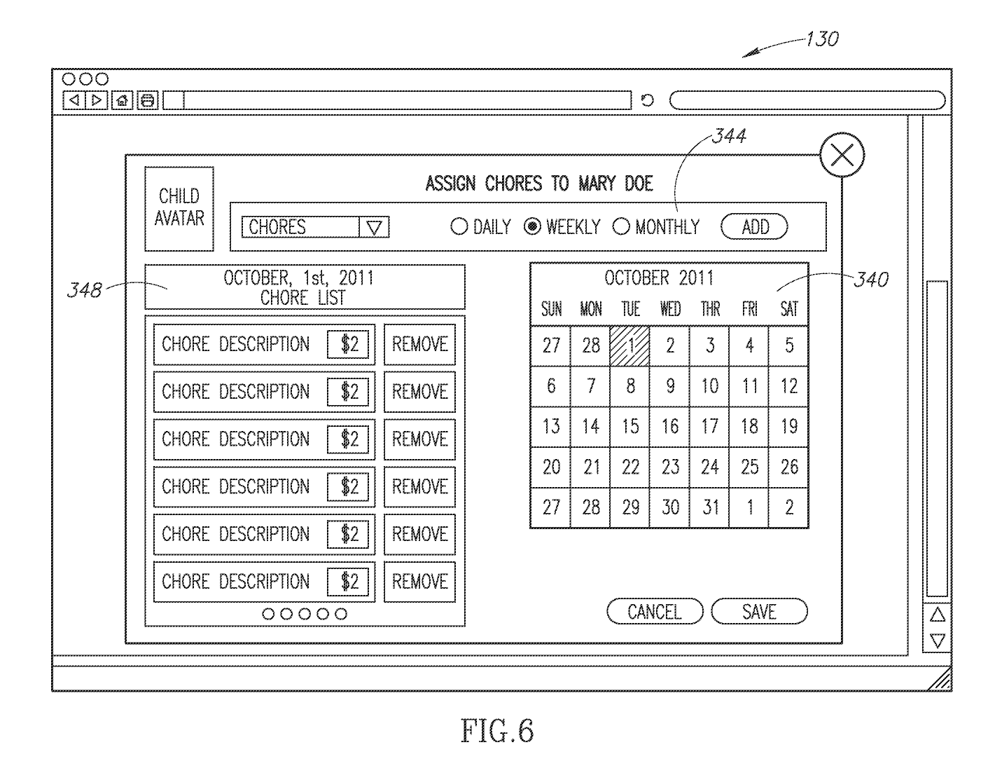

FIG. 6 illustrates a graphical display for the chore assignment module 130 of the system 100. The module 130 includes an add chore section 344 that allows a parent to select a chore from a drop down menu, select the frequency (e.g., daily, weekly, monthly) at which the chore is to be performed, and add it to a list of chores for a particular child. The module 130 includes a daily schedule section 348 that shows the parent a list of chores for the child for a particular day. The parent may choose different days to view by selecting a day from a calendar 340. The parent may also remove chores from the list 348 by selecting a “remove” button next to each of the chores in the list.

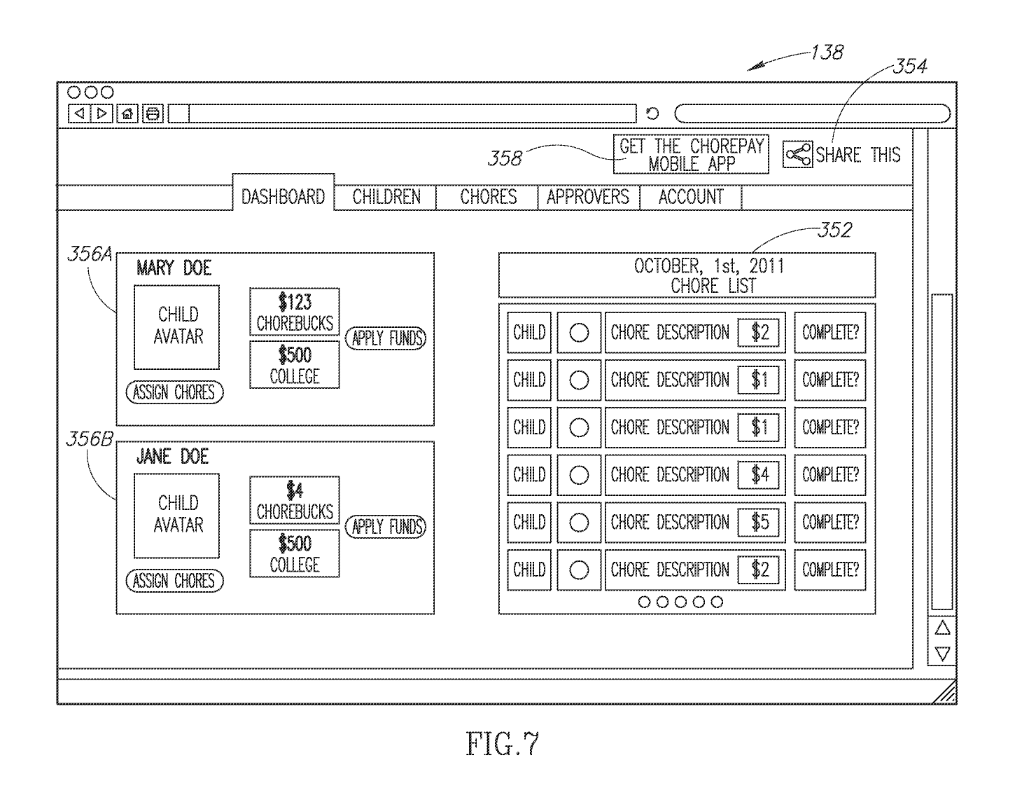

FIG. 7 illustrates a graphical display for the parent dashboard module 138 of the system 100. From the dashboard module 138, the parent can quickly view a list 352 of assigned chores for the day for each child. The list 352 also provides the parent with an indication regarding whether each chore has been completed. The parent dashboard module 138 also includes child information sections 356A and 356B that include buttons for allowing the parent to assign chores to a child and to add funds to one or more of a child's accounts. The child information sections 356A and 356B also show the present value of one or more accounts for each child. The dashboard module 138 also includes a button 358 that directs the parent to a location whereat the parent may download the parent mobile application 174 if he or she has not previously done so. The module 138 further includes a button 354 that allows parents to share system information or the existence of the system 100 with others using email, social media, and the like.

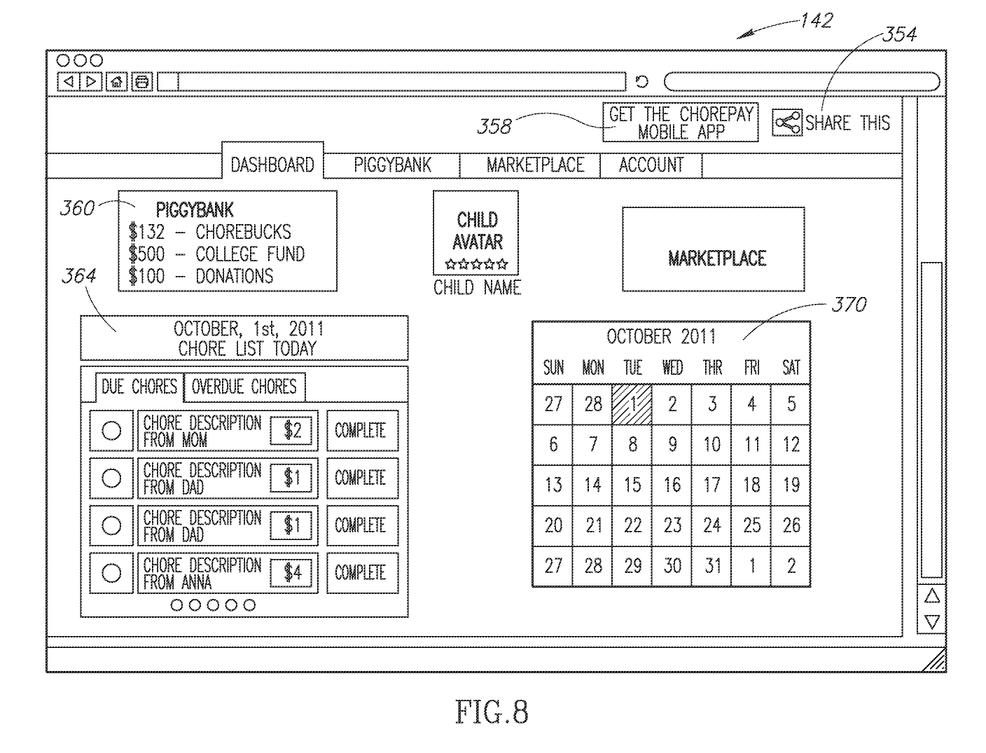

FIG. 8 illustrates a graphical display for the child dashboard module 142 of the system 100. The module 142 provides the child with a calendar 370 that allows the child to select a particular day. Once selected, that day's assigned chores for the child are viewable in a list 364. In the example embodiment shown, the chores in the list 364 are sorted into two groups, “due chores” and “overdue chores.” Once the child has completed a chore, he or she may select a “complete” button in the list 364 next to the chore completed. As discussed above, the system 100 will then send a notification to one or more of the approvers for approval of the completion of the chore.

The child dashboard module also includes an account balance or “piggybank” balance section 360 that provides a snapshot of the present value of each of the child's accounts. In the example shown in FIG. 8, the child has $132 dollars in cash (or “chorebucks”), $500 dollars saved in a college savings account, and $100 dollars saved for donations.

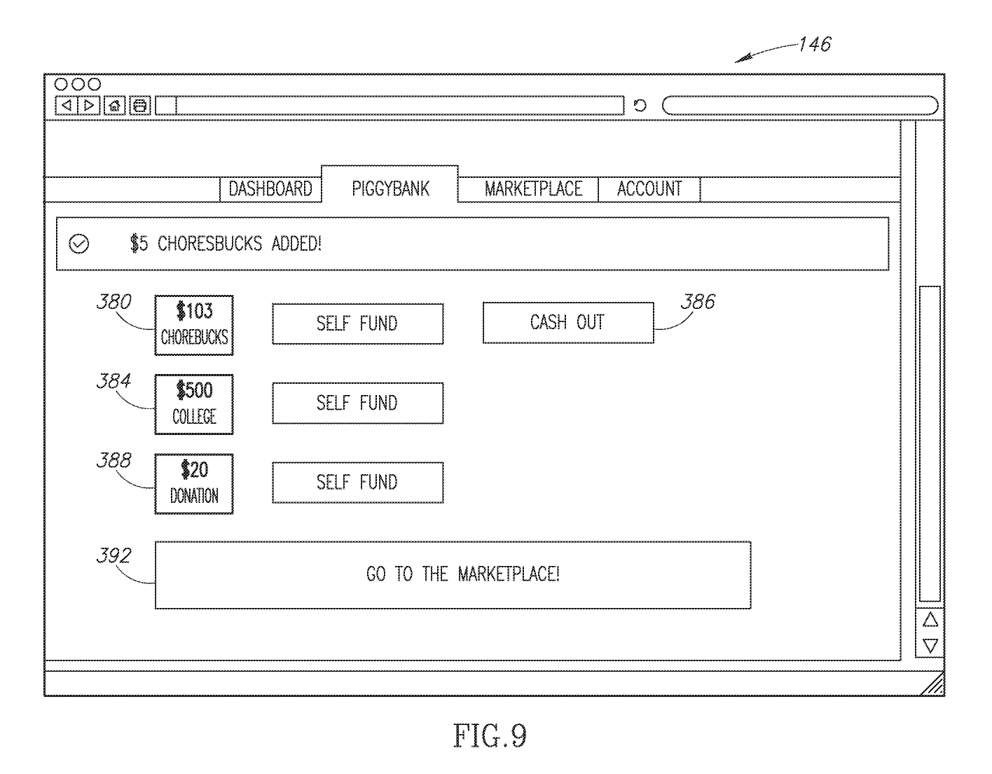

FIG. 9 illustrates a graphical display for the child bank management module 146 of the system 100. From the module 146 the child is able to view account balances and add funds to any of the accounts. In this example, the child has a cash account 380, a college savings account 384, and a donation account 388.

The module 146 may include a “cash out” button 386 that allows a child to request a cash payment for all or a portion of the cash account 380 or other accounts. The payment may be made by any suitable means, including payment by check, electronic payment, etc. The system 100 also allows parents to control which accounts may be accessed by the child. In this example, the child is only able to withdraw or use funds in the cash account 380 and not the college savings account 384 or the donation account 388.

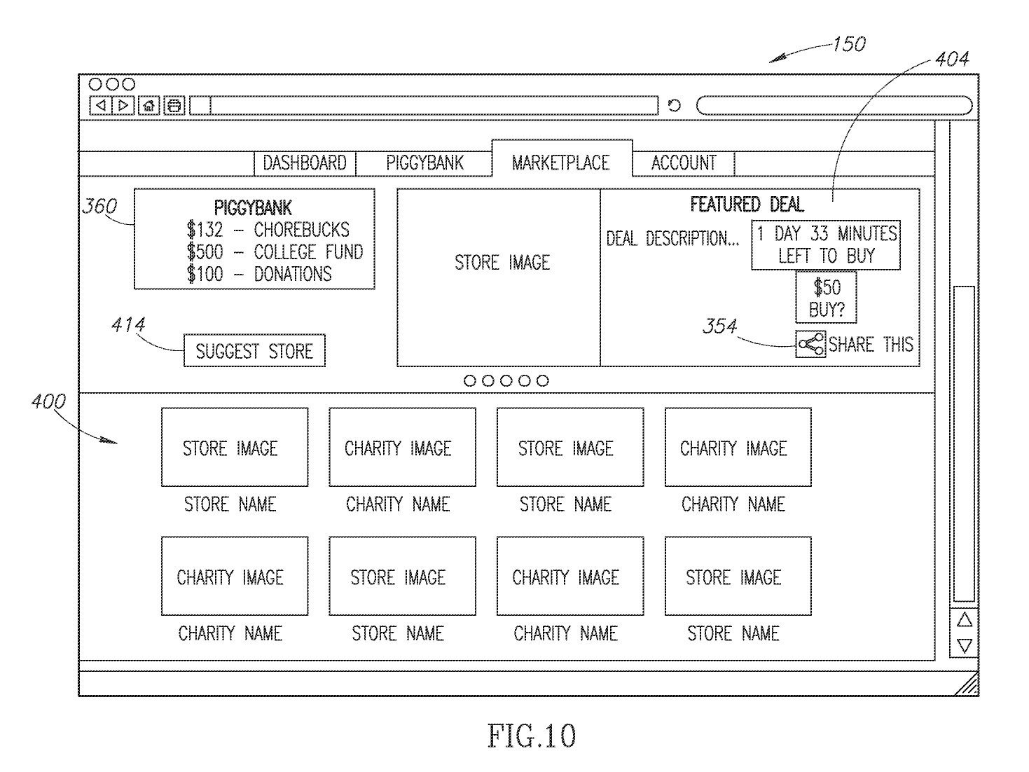

The module 146 also may include a marketplace button 392 that launches the marketplace module 150, shown in FIG. 10. The marketplace module 150 provides an interface that allows a child to spend money from one or more of their accounts at one or more entities (e.g., stores, charities, etc.). The marketplace module 150 includes an entity list section 400 that provides a list of stores, charities, or other entities that are available for the child to spend his or her money. The list 400 may be customized for each child according to various information known about the child, including preferences, physical location, past purchases, and the like. The marketplace module 150 may also include a featured deal section 404 that provides one or more stores that are offering limited-time discounts for one or more products. The module 150 may also include a suggest store button 414 that allows a user to provide a suggestion of one or more stores to be added to the system 100.

In some embodiments, the featured deals provided by the marketplace module 150 may be used as a savings or “cash back” mechanism. For example, the child may be presented with marketing materials via application advertisements identifying products available at discounted rates. If the child chooses to purchase product at the offered discounted price using his or her available cash, the difference between the full price and the discounted price of the product can be automatically deposited into a savings account for the child, such as an education savings account. This feature could help the child build up savings over time.

### Computing System

FIG. 11 is a diagram of hardware and an operating environment in conjunction with which implementations of the art indices generation and reporting processes may be practiced. The description of FIG. 11 is intended to provide a brief, general description of suitable computer hardware and a suitable computing environment in which implementations may be practiced. Although not required, implementations are described in the general context of computer-executable instructions, such as program modules, being executed by a computer, such as a personal computer or the like. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, cloud computing architectures, and the like. Implementations may also be practiced in distributed computing environments where tasks are performed by remote processing devices that are linked through one or more communications networks. In a distributed computing environment, program modules may be located in both local and remote memory storage devices.

The exemplary hardware and operating environment of FIG. 11 includes a general-purpose computing device in the form of a computing device 12. The computing device 12 includes the system memory 22, a processing unit 21, and a system bus 23 that operatively couples various system components, including the system memory 22, to the processing unit 21. There may be only one or there may be more than one processing unit 21, such that the processor of computing device 12 comprises a single central-processing unit (CPU), or a plurality of processing units, commonly referred to as a parallel processing environment. The computing device 12 may be a conventional computer, a distributed computer, a mobile computing device, or any other type of computing device.

The system bus 23 may be any of several types of bus structures including a memory bus or memory controller, a peripheral bus, and a local bus using any of a variety of bus architectures. The system memory 22 may also be referred to as simply the memory, and may include read only memory (ROM) 24 and random access memory (RAM) 25. A basic input/output system (BIOS) 26, containing the basic routines that help to transfer information between elements within the computing device 12, such as during start-up, may be stored in ROM 24. The computing device 12 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media. The computing device 12 may also include one or more other types of memory devices (e.g., flash memory storage devices, and the like).

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, USB drives, and the like) accessible by the processing unit 21 may be considered components of the system memory 22.

A number of program modules may be stored on the hard disk drive 27, magnetic disk 29, optical disk 31, ROM 24, or RAM 25, including an operating system 35, one or more application programs 36, other program modules 37 (e.g., one or more of the modules and applications described above), and program data 38. A user may enter commands and information into the computing device 12 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus 23, but may be connected by other interfaces, such as a parallel port, game port, a universal serial bus (USB), or the like. A monitor 47 or other type of display device is also connected to the system bus 23 via an interface, such as a video adapter 48. In addition to the monitor, computers typically include other peripheral output devices (not shown), such as speakers and printers.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 11 include a local-area network (LAN) 51 and a wide-area network (WAN) 52. Such networking environments are commonplace in offices, enterprise-wide computer networks, intranets and the Internet.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

What is claimed is:

1. A system for facilitating payment for services within a household, the system comprising:
a household payment management server system including payment management software executable thereon and configured to provide an interface for communicating with a plurality of client computing devices over a network, the payment management software being operative to:
receive an assignment of a service and an associated value by a first user to a second user via a client computing device operated by the first user over the network;
send the assigned service to the second user over the network for display on a client computing device operated by the second user;
receive a notification from the second user via a client computing device operated by the second user indicating the assigned service has been completed; and
add funds to one or more accounts associated with the second user by a total amount that corresponds to the value of the completed service after receipt of the notification.

2. The system of claim 1, wherein the payment management software is further operative to send a request for approval to an approver over the network for display on a client computing device operated by the approver, and to receive an approval notification from the approver prior to adding funds to the one or more accounts associated with the second user.

3. The system of claim 1, further comprising a data storage device communicatively coupled with the household payment management system configured to store the assignment of the service and associated value and contact information for the first user, the second user, and the approver.

4. The system of claim 1, wherein the second user is a child and the first user is a parent of the child.

5. The system of claim 1, wherein the payment management software is further operative to receive funds associated with the first user from an external financial institution server.

6. The system of claim 1, wherein the payment management software is further operative to receive a message from the approver via a client computing device operated by the approver, the message relating to the performance of the service by the second user, and to send the message to the second user for display on a client computing device operated by the second user.

7. The system of claim 1, wherein the payment management software is further operative to add funds to one or more accounts associated with the second user by dividing the funds into multiple accounts of the second user according to predetermined percentages.

8. The system of claim 1, wherein the first user and the approver are the same individual.

9. The system of claim 1, wherein the payment management software is further operative to provide the second user with access to an electronic marketplace displayable on a client computing device operated by the second user, the electronic marketplace including one or more goods or services available for purchase by the second user.

10. The system of claim 9, wherein the payment management software is further operative to offer a good or service at a discounted price less than its full price, receive a request from the second user to purchase the good or service at the discounted price using funds from a first account, and add funds to one or more accounts associated with the second user other than the first account by an amount that corresponds to the difference between the full price and the discounted price for the good or service.

11. The system of claim 1, wherein the payment management software is further operative to receive an allocation selection from the first user indicating how funds transferred into multiple accounts of the second user are to be allocated, and to add funds to the one or more accounts associated with the second user by allocating the funds according to the selected allocation.

12. The system of claim 1, wherein the payment management software is further operative to receive an access selection from the first user indicating access rights for the second user for the one or more accounts associated with the second user, and to provide the second user with access rights according to the access selection.

13. The system of claim 1, wherein the payment management software is further operative to send a request for approval to multiple approvers over the network for display on a client computing device operated by each of the approvers.

14. The system of claim 1, wherein the payment management software is further operative to receive a request from the second user for a withdrawal from the one or more accounts associated with the second user, and to send a payment to the second user in response to the request.

15. The system of claim 1, wherein the payment management software is further operative to:
receive an additional selection of a plurality of services and associated values from the first user operating a client computing device; and
receive an additional assignment of the plurality of services to the second user by the first user via the client computing device operated by the first user, wherein at least one of the plurality of services is periodically recurring.

16. The system of claim 1, wherein the payment management software is further operative to communicate with a mobile application executing on a mobile client computing device.

17. A computer implemented method for facilitating payment for services within a household, the method comprising:
receiving a selection of a service and an associated value from a first user operating a computing device;
receiving an assignment of the service to a second user by the first user via the computing device operated by the first user;
sending the assigned service to the second user for display on a computing device operated by the second user;
receiving a notification from the second user via a computing device operated by the second user indicating the assigned service has been completed;
sending a request for approval to an approver for display on a computing device operated by the approver;
receiving an approval notification from the approver; and
after receipt of the approval notification, adding funds to one or more accounts associated with the second user by a total amount that corresponds to the value of the completed service.

18. The method of claim 17, wherein the second user is a child and the first user is a parent of the child.

19. The method of claim 17, further comprising receiving funds associated with the first user from an external financial institution.

20. The method of claim 17, further comprising receiving a message from the approver via a computing device operated by the approver, the message relating to the performance of the service by the second user, and sending the message to the second user for display on a computing device operated by the second user.

21. The method of claim 17, wherein adding funds to one or more accounts associated with the second user comprises dividing the funds into multiple accounts of the second user according to predetermined percentages.

22. The method of claim 17, wherein the first user and the approver are the same individual.

23. The method of claim 17, further comprising providing the second user with access to an electronic marketplace displayable on a computing device operated by the second user, the electronic marketplace including one or more goods or services available for purchase by the second user.

24. The method of claim 23, further comprising offering a good or service at a discounted price less than its full price, receiving a request from the second user to purchase the good or service at the discounted price using funds from a first account, and adding funds to one or more accounts associated with the second user other than the first account by an amount that corresponds to the difference between the full price and the discounted price for the good or service.

25. The method of claim 17, further comprising receiving an allocation selection from the first user indicating how funds transferred into multiple accounts of the second user are to be allocated, wherein adding funds to the one or more accounts associated with the second user comprises allocating the funds according to the selected allocation.

26. The method of claim 17, further comprising receiving an access selection from the first user indicating access rights for the second user for the one or more accounts associated with the second user, and providing the second user with access rights according to the access selection.

27. The method of claim 17, further comprising sending a request for approval to multiple approvers for display on a computing device operated by each of the approvers.

28. The method of claim 17, further comprising receiving a request from the second user for a withdrawal from the one or more accounts associated with the second user, and sending a payment to the second user in response thereto.

29. The method of claim 17, further comprising:
receiving an additional selection of a plurality of services and associated values from the first user operating a computing device; and
receiving an additional assignment of the plurality of services to the second user by the first user via the computing device operated by the first user, wherein at least one of the plurality of services is periodically recurring.

30. An article of manufacture comprising a non-transitory computer readable medium having stored therein components executable by a processor of a computer for performing a process for facilitating payment for services within a household, the process comprising:
receiving a selection of a service and an associated value from a first user operating a computing device;
receiving an assignment of the service to a second user by the first user via the computing device operated by the first user;
sending the assigned service to the second user for display on a computing device operated by the second user;
receiving a notification from the second user via a computing device operated by the second user indicating the assigned service has been completed;
sending a request for approval to an approver for display on a computing device operated by the approver;
receiving an approval notification from the approver; and
after receipt of the approval notification, adding funds to one or more accounts associated with the second user by a total amount that corresponds to the value of the completed service.

31. A system for facilitating payment for services within a household, the system comprising:
a household payment management server system including payment management instructions executable on a processor of the server system and configured to provide an interface for communicating with a plurality of client computing devices over a network, the payment management software being operative to:
receive an assignment of a service and an associated value from a first client computing device operated by a first user over the network;
send the assigned service to a second client computing device operated by a second user over the network;
receive a notification from the second client computing device indicating the assigned service has been completed; and
add funds to one or more accounts associated with the second user by a total amount that corresponds to the value of the completed service after receipt of the notification.
